(19) United States
(12) Patent Application Publication
(10) Pub. No.: US 2014/0131550 A1
(43) Pub. Date: May 15, 2014

(54) OPTICAL TOUCH DEVICE AND TOUCH CONTROL METHOD THEREOF

(71) Applicant: WISTRON CORP., New Taipei City (TW)

(72) Inventors: Chia-Chang Hou, New Taipei City (TW); Chih-Hsiung Chang, New Taipei City (TW)

(73) Assignee: WISTRON CORP., New Taipei City (TW)

(21) Appl. No.: 13/730,395

(22) Filed: Dec. 28, 2012

(30) Foreign Application Priority Data
Nov. 15, 2012 (TW) 101142563

(51) Int. Cl. G06F 3/0488; G06F 3/048

(52) U.S. Cl. CPC G06F 3/0488
USPC 250/206.1

(57) ABSTRACT

An optical touch device and a touch control method thereof are provided. The touch control method is adopted by an optical touch device, including: sensing, by a photoelectric sensor, a presence of an object at a touch location on a touch surface; sensing, by a pressure sensor, a pressure; and when the pressure sensor senses the pressure, determining, by a processor, that a touch event has occurred at the touch location.

### CROSS REFERENCE TO RELATED APPLICATIONS

This Application claims priority of Taiwan Application No. 101142563, filed on Nov. 15, 2012, and the entirety of which is incorporated by reference herein.

### BACKGROUND OF THE INVENTION

1. Field of the Invention

The present invention relates to a touch control mechanism, and in particular, to an optical touch device and a touch control method thereof.

2. Description of the Related Art

An optical touch device utilizes a photoelectric component to acquire images at a touch surface, in order to determine whether an object such as a finger is in contact with the touch surface.

However, since the photoelectric component occupies a finite space, it detects the touched object within a finite height. As a consequence, the detected image is actually above the touch surface, e.g., a certain height above the touch surface. In other words, when the finger is within the finite distance, but not yet in complete contact with the touch surface, the photoelectric component will still regard the event as a touch event, resulting in the false triggering of the touch event.

### BRIEF SUMMARY OF THE INVENTION

A detailed description is given in the following embodiments with reference to the accompanying drawings.

An embodiment of a touch control method is described, adopted by an optical touch device, comprising: sensing, by a photoelectric sensor, a presence of an object at a touch location on a touch surface; sensing, by a pressure sensor, a pressure; and when the pressure sensor senses the pressure, determining, by a processor, that a touch event has occurred at the touch location.

Another embodiment of an optical touch device is provided, comprising a touch surface, a photoelectric sensor, a pressure sensor and a processor. The photoelectric sensor is configured to sense the presence of an object at a touch location on a touch surface. The pressure sensor is configured to sense a pressure. The processor, coupled to the photoelectric sensor and the pressure sensor, is configured to determine that a touch event has occurred at the touch location when the pressure sensor senses the pressure.

### BRIEF DESCRIPTION OF THE DRAWINGS

The present invention can be more fully understood by reading the subsequent detailed description and examples with references made to the accompanying drawings, wherein:

FIG. 1 is a block diagram of an optical touch device 1 according to an embodiment of the invention.

FIG. 2 is a flowchart of a touch control method 2 according to another embodiment of the invention.

FIG. 3 is a flowchart of a touch control method 3 according to another embodiment of the invention.

FIG. 4 is a flowchart of a touch control method 4 according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

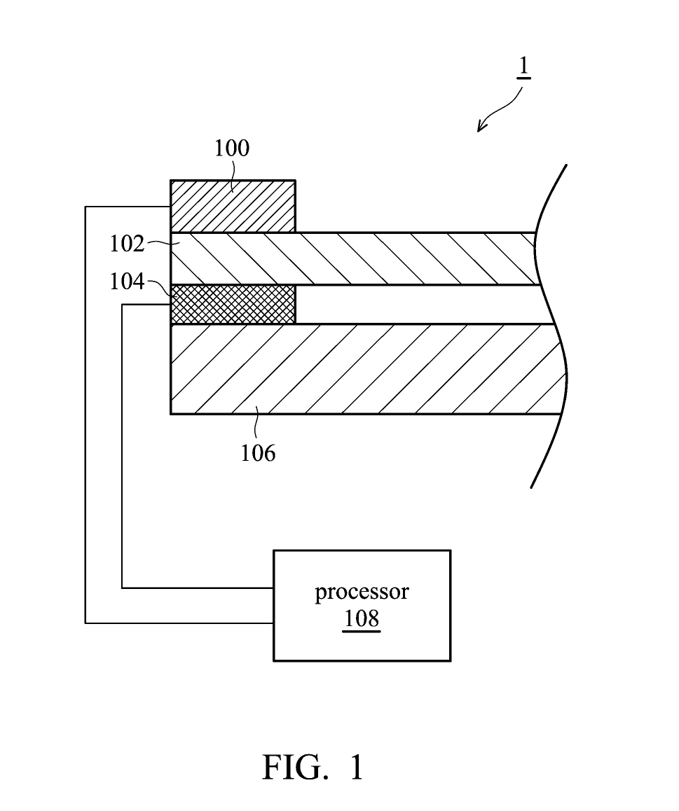

FIG. 1 is a block diagram of an optical touch device 1 according to an embodiment of the invention, including a photoelectric sensor 100, glass 102 (touch screen surface), a pressure sensor 104, a display 106 and a processor 108. The optical touch device 1 may be a smart phone, a tablet, an e-reader, an entertainment device, a projector, a medical device or an electronic device which employs an optical touch mechanism as an input interface and contains a display and a digital processor core. Certain operating systems such as Windows 8 specify that only when a user is in direct contact with the contact surface of the touch device, will the operating system determine that the touch event of the user is valid. If so, the operating system will proceed with subsequent operations based on the valid touch from the user. The optical touch device 1 can detect the physical touch event on the surface of the glass 102 from the user, and report on the touch event to the operating system, so that the required actions may be performed by the operating system.

The photoelectric sensor 100 may be placed above the frame (not shown) of the glass 102. The pressure sensor 104 may be placed between the glass 102 and the display 106, and may be placed outside of the display area of the display 106. In some embodiments, the pressure sensor 104 may be placed at any location below the glass 102 so long as it is able to detect a pressure on the surface of the glass 102. The photoelectric sensor 100 and the pressure sensor 104 are coupled to the processor 108, passing the detected signals therefrom to the processor 108 for determining whether a touch action has occurred.

The frame of the glass 102 includes an array of optical or laser emitters (not shown) attached on the opposite sides of the frame, forming an invisible beam grid. The beam emitters may be an infrared Light Emitted Diode (LED), a red LED, a green LED, a red laser diode or a laser semiconductor capable of emitting a wave with another wavelength. Each type of the beam emitters has a characteristic property, thus selecting an appropriate type of the beam emitters for uses according to the application can produce a preferred detection result. The optical or laser emitters and the photoelectric sensors 100 (receivers) may be disposed at the edges of the optical touch device 1. Corresponding to the optical or laser emitters, the photoelectric sensors 100 are disposed along the frame edge of the glass 102 for detecting the beam grid emitted by the optical or laser emitters. The photoelectric sensors 100 may be a line sensor or an area sensor. In some embodiments, each photoelectric sensor 100 is assigned to a corresponding coordinate or a corresponding area on the touch surface area of the glass 102, and configured to detect the presence of any object at the corresponding coordinate or the corresponding area. When the photoelectric sensor 100 senses the presence of the object it will issue a signal to inform the information to the processor 108. The processor 108 can determine the position of the object on the glass 102 according to the corresponding coordinate or the corresponding area assigned to the photoelectric sensor 100.

The optical sensing mechanism relies on the blockage of the beam grids on the surface of the glass 102. When the arrays of the optical or laser emitters (beam emitters) emit beams with a certain wavelength, the beams from the X and Y axes form the beam grids in a matrix form. The beam emitters can establish the beam by emitting infrared or other frequencies of signals. When the object such as a finger enters the coverage of the beam grids, the light beam is blocked from getting to one or more photoelectric sensors 100 which in response transmits a first sense signal to the processor 108 for identifying X and Y coordinates of the blocked object.

In some embodiments, the photoelectric sensors 100 are located on the opposite side of the beam emitters, detecting the infrared and laser beams within the line-of-sight of the beam emitters. When a user blocks the beam with an object, the emitted beam is cut off in the middle. Consequently, the photoelectric sensors 100 can no longer sense the emitted beams. In another embodiment, the photoelectric sensors 100 are placed on the same side as the beam emitters, a reflector is used to bounce the emitted light beams back from the beam emitters to the photoelectric sensors 100. When the user blocks the light beam with the object, the reflected light beam is blocked, thus, the photoelectric sensors 100 cannot sense the reflected beam. In yet another embodiment, the infrared or laser beams emitted from the beam emitters are reflected off the object on the glass 102 before reaching the photoelectric sensors 100. In turn, the photoelectric sensor 100 can sense the presence of the object on the glass surface 102 by detecting the reflected light beam.

The main purpose of the photoelectric sensor 100 is the position of the photoelectric sensor 100 or glass frame being slightly above the glass 102. Therefore, it is easy to determine the occurrence of the touch event before the finger or a touch stylus pen makes a physical contact with the glass surface 102.

The pressure sensor 104 is located between the display 106 and the glass 102, and positioned at the frame edge of the glass 102. When the pressure sensor 104 senses a pressure, it will send a second sense signal to the processor 108 for determining whether the user has performed a touch or click action on the touch area. When the pressure sensor 104 fails to sense the pressure, and the photoelectric sensor 100 can sense an object on the glass 102, the optical touch device 1 can determine that the object is merely moving above the glass 102. Only when the pressure sensor 104 senses a pressure, will the optical touch device 1 determine that the object is in physical contact with the glass 102. The pressure sensor 104 may be fabricated by a printed circuit board, and be as thin as a sheet of paper. The pressure sensor 104 is placed on the outside of the display area of the display 106 to prevent users from seeing the pressure sensor 104 in the display area.

Once the processor 108 determines that the touch event or the click event has occurred on the touch area of the glass 102, the processor 108 can report the touch event or the click event to the operating system of the optical touch device 1, thereby allowing the operating system to perform a subsequent application program. In some embodiments, the subsequent application program moves the curser to the coordinate corresponding to the photoelectric sensor 100. In other embodiments, the subsequent application program p launches a corresponding application program.

Although the touch surface of the optical touch device 1 is realized by glass 102 in FIG. 1, in some embodiments, the touch surface may be implemented by other materials which are transparent or opaque materials, and may be a material with a planer or a curvy surface. The transparent touch surface may be implemented on a screen of the optical touch device such as a handset or a computer. The opaque touch surface may be implemented on a screen of the optical touch device such as a front projection device, projecting an image from the user to a projection screen.

The optical touch device 1 utilizes the pressure sensor 104 to determine that an object is in physical contact with a touch surface, reducing the likelihood of false triggering of touch events.

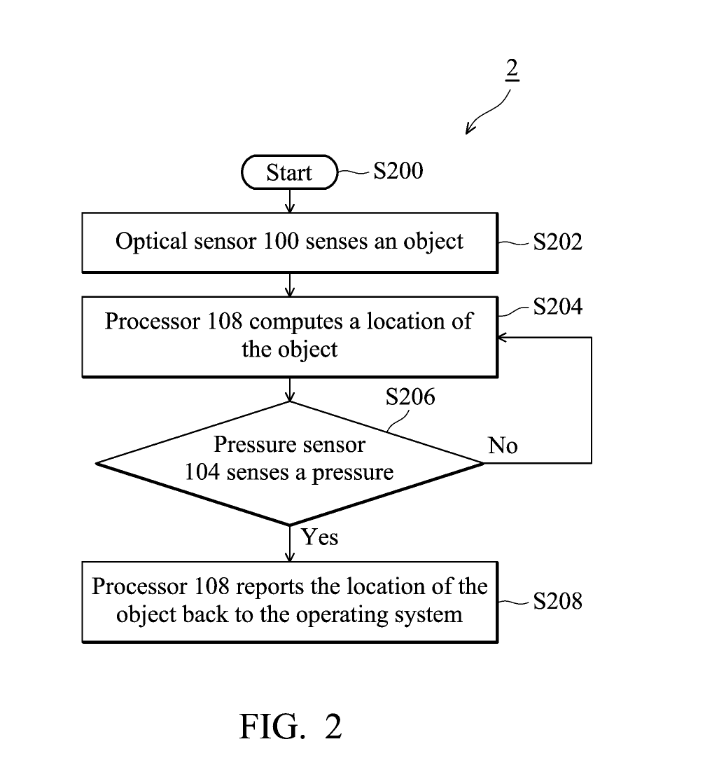

FIG. 2 is a flowchart of a touch control method 2 according to an embodiment of the invention, incorporating the optical touch device 1 in FIG. 1.

Upon startup of the touch control method 2, the relevant parameters and circuits in the optical touch device 1 are initialized, and the processor 108 will load the operating system, the beam emitters will produce the beam grids, and the photoelectric sensor 100 and the pressure sensor 104 will get ready for detecting the touch event from the user (S200). When the user slides a finger over the surface of the glass 102 without actually touching it, the photoelectric sensor 100 is configured to sense the presence of the finger on the glass 102, and generate and pass the first sense signal to the processor 108 (S202). In response, the processor 108 is configured to determine the position of the finger according to the coordinates corresponding to the photoelectric sensor 100 (S204). Upon the finger of the user touching or pressing the touch surface of the glass 102, the pressure sensor 104 is configured to sense the pressure caused by the finger, thereby generating and sending the second sense signal to the processor 108 (S206). When the processor 108 fails to receive the second sense signal, the ? is configured to determine that the finger of the user has merely slid over the touch surface without making substantial physical contact with the glass 102. Therefore, the touch control method 2 returns to Step S204 to continue sensing and determining the position of a user finger. Only when receiving the second sense signal, will the processor 108 determine that the finger of the user is in a direct contact with the glass 102, and report the coordinates and/or the click event of the finger back to the operating system (S208). The operating system can proceed with subsequent programs based on the coordinate position of the finger. In some embodiments, the operating system is configured to move the curser on the display 106 according to the coordinate position of the finger. For example, before the pressure sensor 104 senses the touch action of the finger, the curser is motionless on the display 106. Only after the processor 108 determines that the finger has performed a touch action, will the curser be moved to the coordinates corresponding to the finger position sensed by the photoelectric sensor 100. In other embodiments, the operating system can perform a clicking command on the corresponding position on the display 106 according to the coordinate of the finger and the click event, for example, launching an application program corresponding to the coordinate position.

The touch control method 2 can sense the pressing event from the user by the pressure sensor, providing a method of sensing the object in physical contact with the touch surface, thereby reducing the likelihood of false triggering of the touch event.

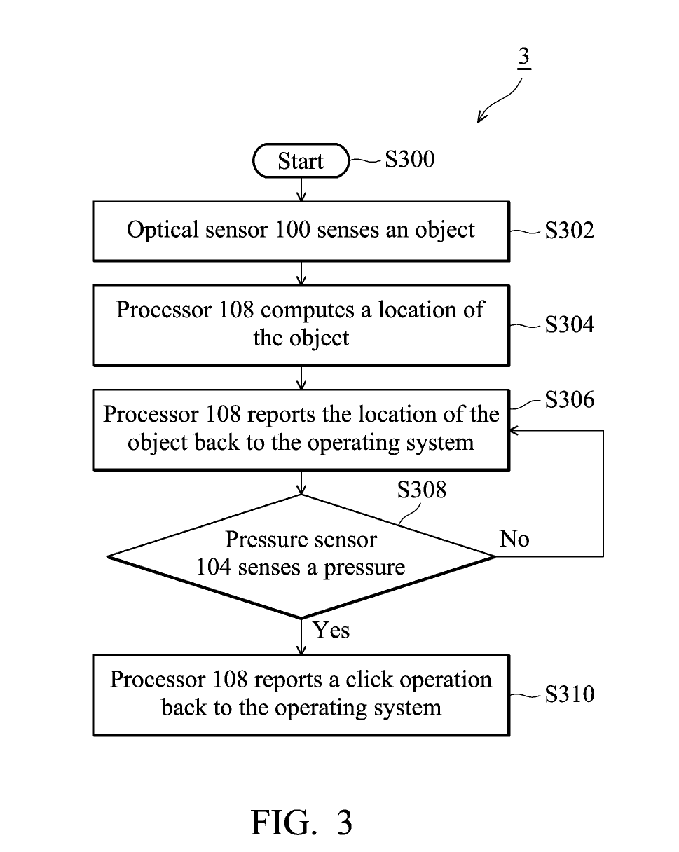

FIG. 3 is a flowchart of a touch control method 3 according to another embodiment of the invention, incorporating the optical touch device 1 in FIG. 1.

The touch control method 3 is similar to the touch control method 2, and is distinguished from the touch control method 2 in that before the pressure sensor 104 senses the touch action of the finger, the processor 108 is configured to report the coordinate position of the finger on the glass to the operating system. In response, the operating system is configured to generate a moving curser such that the curser on the display 106 moves with the coordinate position of the finger. Nevertheless, the operating system is configured not to determine the motion of the finger as a touch or a click event. Only when the pressure sensor 104 senses the pressure caused by the contact of the finger, will the pressure 108 can report the click event to the operating system.

Steps S300, S302, S304 and S308 are identical to Steps S200, S202, S204 and S206, thus, descriptions will not be repeated again for brevity. In Step S306, after the processor 108 determines or computes the coordinates of the finger, a report? of the coordinates is sent to the operating system. In turn, the operating system is configured to produce a curser image so that the curser on the display 106 can move with the finger coordinate. In other words, when the finger slides and moves within the touch range, the curser can still appear to move with the finger on the display 106, yet the operating system is not going to regard the motion of the finger as the touch event or the click event. On the other hand, only after the pressure sensor 104 senses the touch pressure of the finger and the processor 108 determines that the touch event has occurred (S308), will the processor 108 report? the touch event to the operating system. In response, the operating system can generate a click event command at the location of the curser according to the corresponding touch location (S310).

The touch control method 3 can sense the pressing event from the user by the pressure sensor, providing another method of sensing the object in physical contact with the touch surface, thereby reducing the likelihood of false triggering of the touch event.

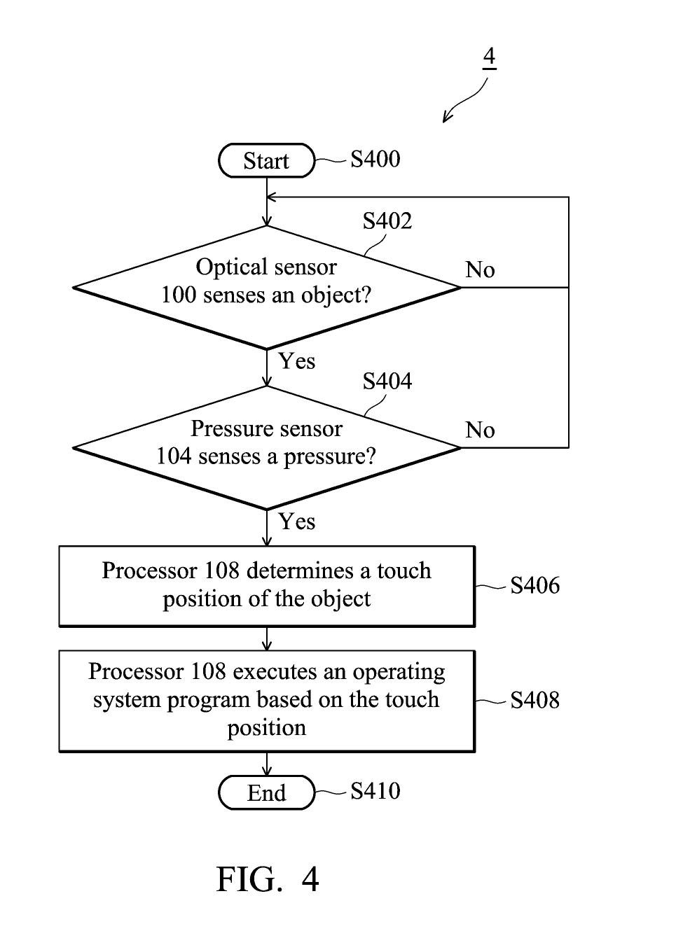

FIG. 4 is a flowchart of a touch control method 4 according to another embodiment of the invention, incorporating the optical touch device 1 in FIG. 1.

Upon startup of the touch control method 4, the parameters and circuits in the optical touch device 1 are initialized, and the processor 108 will load the operating system, the beam emitters will produce the beam grids, and the photoelectric sensor 100 and the pressure sensor 104 will get ready for detecting the touch event from the user (S400). The photoelectric sensor 100 is configured to determine whether an object such as a finger or a touch stylus pen is present at the touch range on the glass 102. When no object is present, the touch control method 4 returns to Step S400 to continue object detection. Upon sensing an object, the photoelectric sensor 100 can produce the first sense signal to the processor 108 to determine the touch location where the object is at (S402). Next the pressure sensor 104 is configured to determine whether a pressure caused by the object has been sensed (S404). If not, the touch control method 4 can return to Step S400 to continue object detection. Upon the sensing of pressure, the photoelectric sensor 104 can produce and send the second sense signal to the processor 108 to determine whether a touch event has occurred at the touch location (S406). The operating system can execute a subsequent program based on the coordinate of the finger (S408). After the subsequent program is completed, the touch control method 4 is exited (S410). In some embodiments, the operating system is configured to move the curser on the display 106 according to the coordinate position of the finger. In other embodiments, the operating system can determine that the touch event is a click event, and perform a clicking command on the corresponding position on the display 106 according to the coordinate of the finger and the click event, for example, launching an application program corresponding to the coordinate position.

The touch control method 4 can sense the pressing event from the user by the pressure sensor, providing another method of sensing the object in physical contact with the touch surface, thereby reducing the likelihood of false triggering of the touch event.

As used herein, the term “determining” encompasses calculating, computing, processing, deriving, investigating, looking up (e.g., looking up in a table, a database or another data structure), ascertaining and the like. Also, “determining” may include resolving, selecting, choosing, establishing and the like.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine.

The operations and functions of the various logical blocks, modules, and circuits described herein may be implemented in circuit hardware or embedded software codes that can be accessed and executed by a processor.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch control method, adopted by an optical touch device, comprising:
sensing, by a photoelectric sensor, a presence of an object at a touch location on a touch surface;
sensing, by a pressure sensor, a pressure; and wherein
when the pressure sensor senses the pressure, determining, by a processor, that a touch event has occurred at the touch location.

2. The touch control method of claim 1, further comprising when determining that the touch event has occurred at the touch location, executing, by the processor, an operating system program based on the touch location.

3. The touch control method of claim 2, further comprising:
when determining that the touch event has occurred at the touch location, determining, by the processor, that a click event has occurred based on the touch location and the touch event; and
executing, by the processor, the operating system program based on the click event.

4. The touch control method of claim 1, wherein the sensing by the photoelectric sensor step comprises:
assigning the touch location to the photoelectric sensor; and
when the photoelectric sensor senses the presence of the object, the processor determines that the object is present at the touch location.

5. The touch control method of claim 1, wherein the pressure sensor is located below an edge of the touch surface of the optical touch device.

6. The touch control method of claim 1, wherein the pressure sensor is located between the touch surface of the optical touch device and a display of the optical touch device.

7. An optical touch device, comprising:
a touch surface;
a photoelectric sensor, configured to sense the presence of an object at a touch location on a touch surface;
a pressure sensor, configured to sense a pressure; and
a processor, coupled to the photoelectric sensor and the pressure sensor, when the pressure sensor senses the pressure, configured to determine that a touch event has occurred at the touch location.

8. The optical touch device of claim 7, wherein the pressure sensor is located below an edge of the touch surface of the optical touch device.

9. The optical touch device of claim 7, wherein the pressure sensor is located between the touch surface of the optical touch device and a display of the optical touch device.

10. The optical touch device of claim 7, wherein when determining that the touch event has occurred at the touch location, the processor is configured to execute an operating system program based on the touch location.

11. The optical touch device of claim 10, wherein when determining that the touch event has occurred at the touch location, the processor is configured to determine that a click event has occurred based on the touch location and the touch event, and the operating system program is executed based on the click event.

12. The optical touch device of claim 7, wherein the processor is configured to assign the touch location to the photoelectric sensor, and when the photoelectric sensor senses the presence of the object, the processor is configured to determine that the object is present at the touch location.
